(19) United States
(12) Patent Application Publication
(10) Pub. No.: US 2020/0057569 A1
(43) Pub. Date: Feb. 20, 2020

(54) SYSTEM AND METHOD FOR SECURE DATA REPLICATION ON DRILLING MANAGEMENT SYSTEMS

(71) Applicant: Schlumberger Technology Corporation, Sugar Land, TX (US)

(72) Inventors: Juan Rojas, Sugar Land, TX (US); Wilson Silva dos Santos, JR., Katy, TX (US)

(21) Appl. No.: 16/104,272

(22) Filed: Aug. 17, 2018

(51) Int. Cl. G06F 3/06; G06F 9/455; G06F 8/61; G06F 8/65; G06F 21/57; G05B 19/05; E21B 41/00; E21B 44/00

(52) U.S. Cl. CPC G06F 3/067; G06F 9/45558; G06F 8/63; G06F 8/65; G06F 21/572; G05B 19/05; G05B 2219/1101; G06F 3/0659; E21B 41/0092; E21B 44/00; G06F 2009/45562; G06F 2221/033; G06F 3/0604

(57) ABSTRACT

A method may include obtaining, over a network connection, data between a remote device and a drilling management network. The method may further include determining a persistent storage device among various persistent storage devices that corresponds to a predetermined data type associated with the data. The method may further include storing the data in the persistent storage device associated with the predetermined data type. The method may further include transmitting the data in the persistent storage device to a network device in the drilling management network.

### BACKGROUND

Various network devices may be disposed throughout a drilling rig in order to control various operations on the drilling rig. These network devices may be dedicated systems that control drilling equipment, monitor the performance of the drilling rig, and/or perform various maintenance operations with respect to the drilling rig. Traditionally, when an upgrade was desired for a dedicated system, a person was sent onsite to execute manually the process for updating the system. This manual update process was rare as many dedicated systems did not change dramatically over time. However, as systems become more advance, updates may be implemented on a more regular basis. Therefore, there is a balance of risk between opening a drilling rig to remote attacks and sending a person onsite to execute manually the process for updating a system. Thus, data infrastructure in drilling rigs is desired that can provide secure data management to drilling rig systems and that may also scale according to changing numbers of systems and changing time requirements for transferring data.

### SUMMARY

In general, in one aspect, the disclosed technology relates to a system. The system includes various persistent storage devices disposed within a drilling management network. The system further includes a control system that includes a programmable logic controller (PLC) configured for managing a drilling process. The system further includes a data management controller coupled to the persistent storage devices. The system further includes various network devices coupled to the data management controller, the control system, and the persistent storage devices. The data management controller obtains data from a remote device over a network connection with the drilling management network. The data management controller determines a persistent storage device among the persistent storage devices that corresponds to a predetermined data type associated with the data. The data management controller stores the data in the persistent storage device associated with the predetermined data type.

In general, in one aspect, the disclosed technology relates to a method. The method includes obtaining, over a network connection, data between a remote device and a drilling management network. The method further includes determining a persistent storage device among various persistent storage devices that corresponds to a predetermined data type associated with the data. The method further includes storing the data in the persistent storage device associated with the predetermined data type. The method further includes transmitting the data in the persistent storage device to a network device in the drilling management network.

In general, in one aspect, the disclosed technology relates to a method. The method includes obtaining a request for data from a network device located in a drilling management network. The method further includes determining whether a network operating condition of the drilling management network corresponds to a production condition. The drilling management network performs one or more drilling operations during the production condition. The method further includes determining, in response to the network operating condition corresponding to the production condition, a production persistent storage device among various persistent storage devices that corresponds to a predetermined data type associated with the data. The method further includes transmitting the data from the production persistent storage device to the network device.

Other aspects of the disclosure will be apparent from the following description and the appended claims.

### BRIEF DESCRIPTION OF DRAWINGS

FIGS. 1, 2.1, and 2.2 show systems in accordance with one or more embodiments.

FIGS. 3 and 4 show flowcharts in accordance with one or more embodiments.

FIG. 5 shows an example in accordance with one or more embodiments.

FIGS. 6.1 and 6.2 show a computing system in accordance with one or more embodiments.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include a system and various methods for providing a data management architecture within a drilling management network. In particular, one or more embodiments are directed to a system that includes a data management controller that administers data transfers between the drilling management network and remote devices. In some embodiments, for example, the network connection is a low throughput connection. As such, the data management controller may administer the transfer of various data files using the low throughput connection over a predetermined amount of time. After completion of the data transfers, the data files are stored in various persistent storage devices based on predetermined data types, such as software images, data models, etc. In some embodiments, persistent storage devices are segregated based on data associated with various network operating conditions, such as production conditions and staging conditions. For example, staging conditions may be where software and/or hardware in a drilling management network is undergoing tests prior to use in actual production conditions.

Once data is stored in persistent storage devices, various security protocols may be implemented on the drilling management network to enable safe usage of the data by network devices throughout the drilling management network. For example, by maintaining data in a corresponding persistent storage device, the drilling management network may maintain data redundancy in case a network device, such as a virtual machine or software container, terminates operations with the corresponding data. Accordingly, the data management controller and the persistent storage devices may provide a clear chain of data transportation for how data enters the drilling management network and is transmitted to specific systems in the drilling management network. For example, when a particular version of a software application interferes with one or more processes in a control system, the data management controller may map data associated with the version back from the installation of the software application to the corresponding persistent storage device and back to the source of the data and time of arrival into the network.

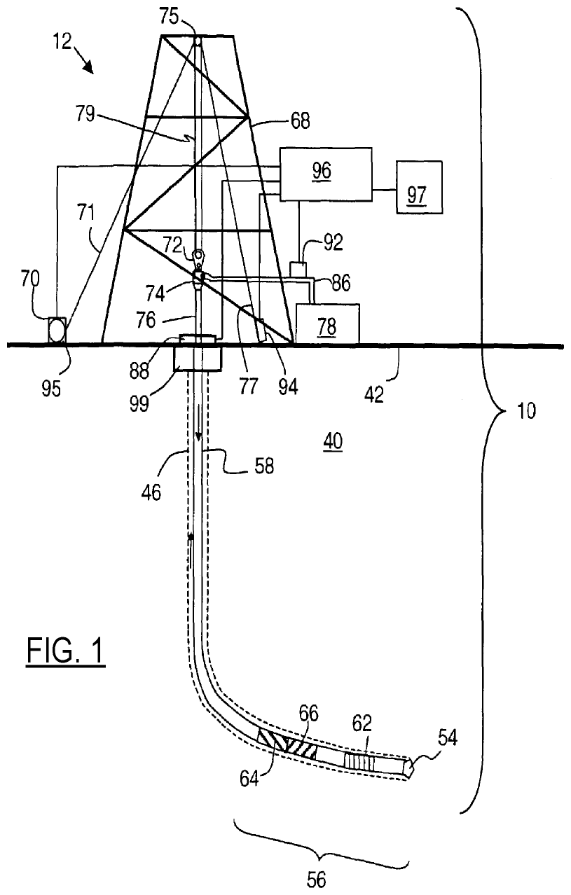

FIG. 1 shows a block diagram of a system in accordance with one or more embodiments. FIG. 1 shows a drilling system (10) according to one or more embodiments. Drill string (58) is shown within borehole (46). Borehole (46) may be located in the earth (40) having a surface (42). Borehole (46) is shown being cut by the action of drill bit (54). Drill bit (54) may be disposed at the far end of the bottom hole assembly (56) that is attached to and forms the lower portion of drill string (58). Bottom hole assembly (56) may include a number of devices including various subassemblies. Measurement-while-drilling (MWD) subassemblies may be included in subassemblies (62). Examples of MWD measurements may include direction, inclination, survey data, downhole pressure (inside the drill pipe, and/or outside and/or annular pressure), resistivity, density, and porosity. Subassemblies (62) may also include a subassembly for measuring torque and weight on the drill bit (54). The signals from the subassemblies (62) may be processed in a processor (66). After processing, the information from processor (66) may be communicated to pulser assembly (64). Pulser assembly (64) may convert the information from the processor (66) into pressure pulses in the drilling fluid. The pressure pulses may be generated in a particular pattern which represents the data from the subassemblies (62). The pressure pulses may travel upwards though the drilling fluid in the central opening in the drill string and towards the surface system. The subassemblies in the bottom hole assembly (56) may further include a turbine or motor for providing power for rotating and steering drill bit (54).

The drilling rig (12) may include a derrick (68) and hoisting system, a rotating system, and/or a mud circulation system, for example. The hoisting system may suspend the drill string (58) and may include draw works (70), fast line (71), crown block (75), drilling line (79), traveling block and hook (72), swivel (74), and/or deadline (77). The rotating system may include a kelly (76), a rotary table (88), and/or engines (not shown). The rotating system may impart a rotational force on the drill string (58). Likewise, the embodiments shown in FIG. 1 may be applicable to top drive drilling arrangements as well. Although the drilling system (10) is shown being on land, those of skill in the art will recognize that the described embodiments are equally applicable to marine environments as well.

The mud circulation system may pump drilling fluid down an opening in the drill string. The drilling fluid may be called mud, which may be a mixture of water and/or diesel fuel, special clays, and/or other chemicals. The mud may be stored in mud pit (78). The mud may be drawn into mud pumps (not shown), which may pump the mud though stand pipe (86) and into the kelly (76) through swivel (74), which may include a rotating seal. Likewise, the described technologies may also be applicable to underbalanced drilling. If underbalanced drilling is used, at some point prior to entering the drill string, gas may be introduced into the mud using an injection system (not shown).

The mud may pass through drill string (58) and through drill bit (54). As the teeth of the drill bit (54) grind and gouge the earth formation into cuttings, the mud may be ejected out of openings or nozzles in the drill bit (54). These jets of mud may lift the cuttings off the bottom of the hole and away from the drill bit (54), and up towards the surface in the annular space between drill string (58) and the wall of borehole (46).

At the surface, the mud and cuttings may leave the well through a side outlet in blowout preventer (99) and through mud return line (not shown). Blowout preventer (99) comprises a pressure control device and a rotary seal. The mud return line may feed the mud into one or more separator (not shown) which may separate the mud from the cuttings. From the separator, the mud may be returned to mud pit (78) for storage and re-use.

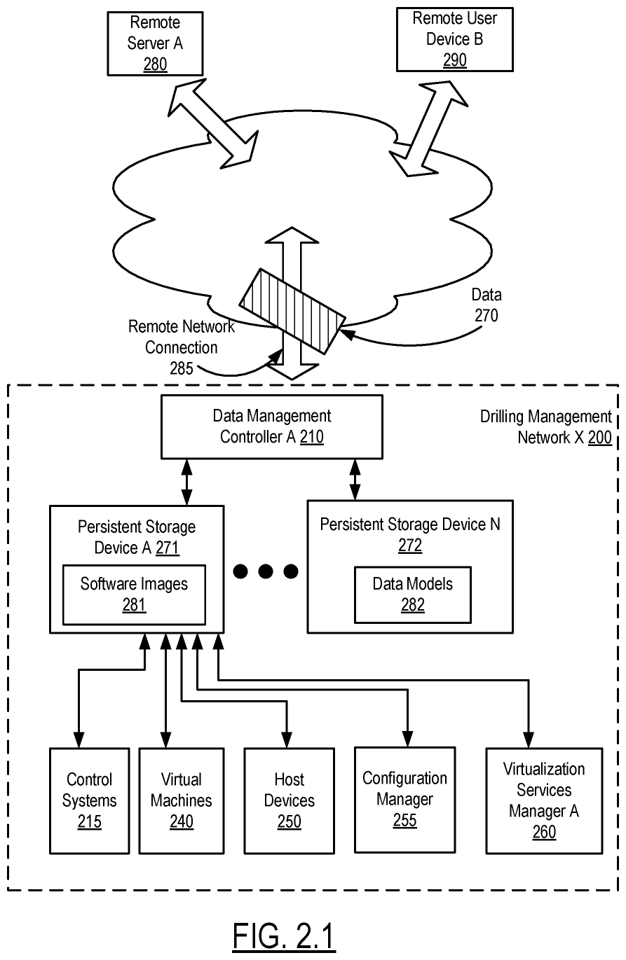

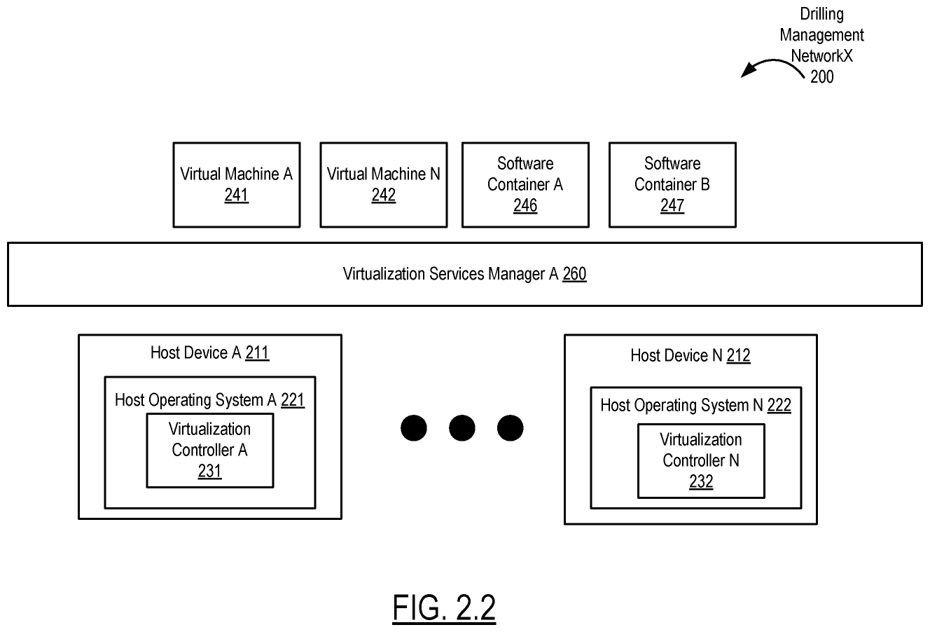

Various sensors may be placed on the drilling rig (12) to take measurements of the drilling equipment. In particular, a hookload may be measured by hookload sensor (94) mounted on deadline (77), block position and the related block velocity may be measured by a block sensor (95) which may be part of the draw works (70). Surface torque may be measured by a sensor on the rotary table (88). Standpipe pressure may be measured by pressure sensor (92), located on standpipe (86). Signals from these measurements may be communicated to a surface processor (96) or other network elements (not shown) disposed around the drilling rig (12). In addition, mud pulses traveling up the drillstring may be detected by pressure sensor (92). For example, pressure sensor (92) may include a transducer that converts the mud pressure into electronic signals. The pressure sensor (92) may be connected to surface processor (96) that converts the signal from the pressure signal into digital form, stores and demodulates the digital signal into useable MWD data. According to various embodiments described above, surface processor (96) may be programmed to automatically detect one or more rig states based on the various input channels described. Processor (96) may be programmed, for example, to carry out an automated event detection as described above. Processor (96) may transmit a particular rig state and/or event detection information to user interface system (97) which may be designed to warn various drilling personnel of events occurring on the rig and/or suggest activity to the drilling personnel to avoid specific events. As described below, one or more of these equipments may be operated by a drilling management network coupled to the drilling rig (12). For example, the drilling management network X (200) described below in FIGS. 2.1 and 2.2 may automate one or more drilling processes associated with these equipments without manual human intervention.

Turning to FIG. 2.1, FIG. 2.1 shows a block diagram of a system in accordance with one or more embodiments. As shown in FIG. 2.1, a drilling management network (e.g., drilling management network X (200)) may include a data management controller (e.g., data management controller A (210)) coupled to various persistent storage devices (e.g., persistent storage device A (271), persistent storage device N (272)) and various network elements (not shown). A persistent storage device may include hardware and/or software that includes functionality to implement nonvolatile data storage. For example, a persistent storage device may include a persistent disk, such as a hard disc drive and/or a solid state drive in a central data repository.

In one or more embodiments, a persistent storage device is a virtual machine or software container that includes functionality for accessing and/or providing data for a predetermined data type. For example, in some embodiments, the persistent storage device includes functionality to provide data without using a data management controller as an intermediary, e.g., a persistent storage device may directly receive requests for data from within a drilling management network. Thus, the persistent storage device may be decentralized and separate from a data management controller.

In one or more embodiments, a data management controller includes hardware and/or software that includes functionality for managing storage and/or retrieval of data with respect to various persistent storage devices. For example, the data management controller may be part of a central data repository that includes various persistent storage devices in a drilling management network. Likewise, the data management controller may establish one or more network connections (e.g., remote network connection (285)) to one or more remote devices (e.g., remote server A (280), remote user device B (290)). As such, the data management controller may administer the transfer of data between a remote device and the drilling management network.

In some embodiments, the data management controller administers high volume time-controlled data transfers to the drilling management network. For example, the data management controller may monitor network traffic into and out of the network to determine a predetermined period of time when a data transfer does not interfere production operations. Accordingly, as a remote network connection may be a low throughput connection, the data management controller may perform a data transfer over one or more time periods to complete the data transfer. Upon obtaining data at the drilling management network, the data management controller may include functionality to identify one or more predetermined data types associated with the data and store the data in a persistent storage device associated with the predetermined data type.

In one or more embodiments, a persistent storage device is associated with software images (e.g., software images (281)). For example, the persistent storage device may include various software images for different software versions used by network devices throughout a drilling management network. For example, the drilling management network X (200) may include a configuration manager (255) that includes hardware and/or software with functionality to determine whether a software update exists for one or more networks devices. Upon detecting the software update, the configuration manager (255) may access persistent storage device A (271) to obtain a software image for the corresponding software update. In another embodiment, a persistent storage device is associated with network configurations for various control systems and other network devices for different network operating conditions. As such, a configuration manager may adjust network save and/or adjust network configuration for various virtual machines, software containers, and other network devices throughout the drilling management network using one or more persistent storage devices.

Keeping with FIG. 2.1, the drilling management network X (200) may further include various network devices (e.g., control systems (215), virtual machines (240), host devices (250), virtualization services manager A (260)). For example, network devices may include one or more host devices that include hardware and/or software that is coupled to drilling equipment (e.g., one or more programmable logic controllers (PLCs)). The drilling equipment may include the blowout preventer (99), the drilling rig (12), and other components described above in FIG. 1 and the accompanying description.

PLCs coupled to host devices may form various control systems (e.g., control systems (215)), such as various drilling operation control systems and various maintenance control systems. In particular, PLCs may include hardware and/or software with functionality to control one or more processes performed by a drilling rig, including, but not limited to the components described in FIG. 1. Specifically, a PLC may control valve states, fluid levels, pipe pressures, warning alarms, and/or pressure releases throughout a drilling rig. Moreover, a programmable logic controller may be a ruggedized computer system with functionality to withstand vibrations, extreme temperatures, wet conditions, and/or dusty conditions, for example, around a drilling rig.

Returning to the persistent storage devices, in some embodiments, a persistent storage device is associated with data models (e.g., data models (282)). Data models may include various databases for geology and production data, drilling data, 3D models, nonwell related data, acquired data from drilling operations, etc. Likewise, data models may also include different versions of the same data, e.g., data acquired at different times and/or updated data versions based on later drilling operations. For example, one or more control processes performed by various control systems may use the data models to perform one or more drilling operations. In another embodiment, a user analyzes past drilling operations using one or more data models obtained from the persistent storage devices.

Turning to FIG. 2.2, a virtualization services manager (e.g., virtualization services manager A (260)) may include hardware and/or software that includes functionality for generating, terminating, monitoring, and/or managing one or more virtual machines (e.g., virtual machine A (241), virtual machine N (242)) and/or software containers (e.g., software container A (246), software container N (247)) operating on a virtualization services layer of a drilling management network. In some embodiments, a virtualization services manager includes a hypervisor for managing one or more virtualized environments on a drilling management network. For example, virtualization services may be implemented in one or more network layers on the drilling management network, e.g., where virtual machines and/or software containers operate on the network layers. Rather than implementing a virtual machine or software container on a single host device, for example, virtualization services may be implemented using a virtual machine or software container that operates on multiple host devices. Examples of virtualization services may include oilfield data management among PLCs and/or drilling equipment, virtual machine management, software container management, memory resource allocation among host devices on a drilling management network, various network processes for administering the drilling management network, etc. For example, a virtualization services manager may communicate with the virtual machines and software containers to stop and/or initiate virtualization services that are being performed by the virtual machines and software containers.

In one or more embodiments, a host device includes a virtualization controller (e.g., virtualization controller A (231), virtualization controller N (232)) operating on a host operating system (e.g., host operation system A (221), host operating system N (222)). A virtualization controller may include hardware and/or software that includes functionality for communicating with other virtualization controllers on a drilling management network and/or implementing various virtualization services on the drilling management network. For example, virtualization controllers may be virtual machines or software containers operating on the host devices (211, 212). Virtualization services may include network processes that are operated on multiple network devices (e.g., host devices (211, 212), network elements (205), host devices (213)).

Furthermore, a software container may be a user-space instance implemented by a single kernel of a host operating system (e.g., host operating system A (221), host operating system N (222)). In particular, a software container may be an abstraction at an application layer that allows isolated processes to operate inside the software container. Likewise, multiples software containers may operate on a single kernel of an operating system. Software containers may include docker containers, Java™ containers, Windows Server® containers, etc. In contrast, a virtual machine may include hardware and/or software that may provide an abstraction of physical hardware. For example, a virtual machine may have an independent operating system that is separate from a host operating system where a virtual machine may operate on one or more host devices with dedicated memory and other computer resources.

Moreover, a virtualization services manager (e.g., virtualization services manager A (260)) may administer and/or monitor various host device resources for virtual machines and/or software containers operating on a virtualization services layer. Likewise, the virtualization general architecture of the drilling management network X (200) may be the same where a host operating system is running on bare metal (e.g., a hardware computing system), or as a virtual machine. For example, virtual machines and software containers may communicate with each other in the virtualization services layer and run virtualization services in an orchestrated manner.

Furthermore, a drilling management network may include user devices that may include hardware and/or software coupled to the drilling management network. User devices may be network devices that include functionality for presenting data and/or receiving inputs from a user regarding various drilling operations and/or maintenance operations performed within the drilling management network. For example, a user device may include personal computers, smartphones, human machine interfaces, and any other devices coupled to a network that obtain inputs from one or more users, e.g., by providing a graphical user interface (GUI). Likewise, a user device may present data and/or receive control commands from a user for operating a drilling rig. A network element may refer to various software and/or hardware components within a network, such as switches, routers, hubs, user equipment, or any other logical entities for uniting one or more physical devices on the network.

While FIGS. 1, 2.1, and 2.2 show various configurations of components, other configurations may be used without departing from the scope of the disclosure. For example, various components in FIGS. 1, 2.1 and 2.2 may be combined to create a single component. As another example, the functionality performed by a single component may be performed by two or more components.

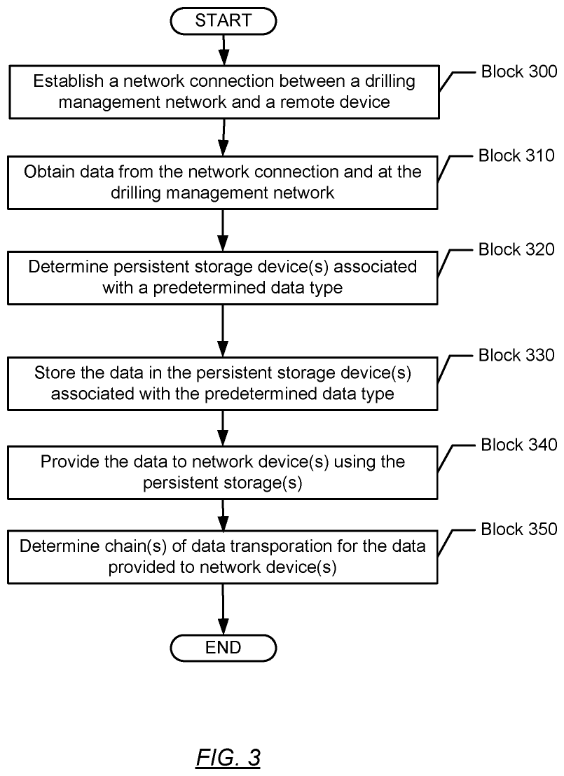

Turning to FIG. 3, FIG. 3 shows a flowchart in accordance with one or more embodiments. Specifically, FIG. 3 describes a method for storing and/or providing data to network devices in a drilling management network. One or more blocks in FIG. 3 may be performed by one or more components (e.g., data management controller A (210)) as described in FIGS. 1, 2.1 and 2.2. While the various blocks in FIG. 3 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 300, a network connection is established between a drilling management network and a remote device in accordance with one or more embodiments. For example, the network connection may be a low throughput network connection that transfers rig specific data and/or common rig data to the drilling management network. The network connection may be established by a data management controller operating on the drilling management network. In particular, the network connection may be established at predetermined times and for specific intervals to allow the transfer of data without interfering with drilling or production operations. For example, the predetermined times may correspond to periods when control systems are offline and/or remote users are unlikely to be accessing the drilling management network over a remote network connection.

In Block 310, data is obtained from a network connection and at a drilling management network in accordance with one or more embodiments. For data transfers to a drilling management network, various limitations may exist. For example, a low throughput network connection may have high latency and limited availability or downlink time. As such, small amounts of data may be transferred without a problem, while a large data transfer may involve multiple days to complete the data transfer. A data management controller may maintain a constant data transmission over one or more time intervals to obtain the data in Block 310.

In Block 320, one or more persistent storage devices are determined that are associated with a predetermined data type in accordance with one or more embodiments. For example, data obtained from a network connection may be identified based on a predetermined set of data types. For example, data may include embedded metadata that specifies one or more data types for the data. On the other hand, a data management controller or other network device may analyze the data based on the data sender to determine data types associated with the data.

In Block 330, data is stored in one or more persistent storage devices associated with a predetermined data type in accordance with one or more embodiments. In response to determining a data type associated with the data, the data may be relayed over the drilling management network to the corresponding persistent storage device. The storing process may include recording a time stamp when the data was transmitted by a source and/or obtained at the drilling management network. Likewise, the data may be entered into one or more databases for later access. For example, if the data corresponds to a software image, a data management controller may store the software image based on the software version as well as any control systems that use software applications based on the software image.

In Block 340, data is provided to one or more network devices using one or more persistent storage devices in accordance with one or more embodiments. For example, a data management controller may act an intermediary between obtaining requests for data and providing access to network devices seeking the data. Moreover, once data is store in a persistent storage device, the persistent storage device may directly obtain requests for data and provide access to the data accordingly.

In one or more embodiments, data is provided from a persistent storage device to network devices using a jump host. For example, a jump host may implement a temporary conduit that is established and terminated in order to regulate authorized access to the persistent storage device. For example, a temporary conduit may limit network device access to specific times and/or to specifically authorized network devices. Thus, a temporary conduit may provide a communication path between network devices located in different security zones during authorized time periods. In one or more embodiments, a temporary conduit is a switched virtual connection. For example, a switched virtual connection may include hardware and/or software on two security zones in a drilling management network for implementing a virtual connection. Thus, when the switched virtual connection is “open”, no virtual connection may exist across the temporary conduit. When the switched virtual connection is “closed”, a virtual connection is formed that corresponds to a temporary virtual circuit. The temporary virtual circuit may then provide transmission of network traffic, such as persistent storage data, between two security zones.

In Block 350, one or more chains of data transportation are determined for data provided to one or more network devices in accordance with one or more embodiments. In particular, a chain of data transportation may include information regarding how data enters and is used by network devices within a drilling management network. For example, a chain of data transportation may be determined and/or stored by a persistent storage device, a data management controller, or other network device in the drilling management network. In some embodiments, the chain of data transportation describes the source (e.g., identification information for a remote device that transmits particular data to a drilling management network), date information such as one or more timestamps, and other information regarding when data enters the drilling management network and passes to one or more persistent storage devices. A chain of data transportation may also describe usage data by various network devices accessing the data from a respective persistent storage device. In some embodiments, a chain of data transportation includes information regarding use of particular data in staging operations, validation operations, and/or production operations.

In some embodiments, to determine a chain of data transportation, a data management controller records timestamp, version information, data requests, edit history, and other metadata regarding data associated with one or more persistent storage devices. For example, the data management controller may log any data requests transmitted by network devices to a persistent storage device. Likewise, the data management controller may record modifications to software and other data produced during staging operations, validation operations, and/or production operations. Thus, a persistent storage device may include multiple versions of the same data based on changes made to the data upon leaving and/or returning to a persistent storage device.

In some embodiments, a network device or an operator analyzes a chain of data transportation to identify one or more problems within a drilling management network. For example, if modified software code produces a malfunctioning control system, a chain of data transportation may identify when the software code was modified by one or more network devices. Likewise, using the chain of data transportation, other software images may be identified that had similar modifications. In contrast, without a chain of data transportation, the date, type, and/or source of the modification may be unknown during analysis of the malfunctioning control system.

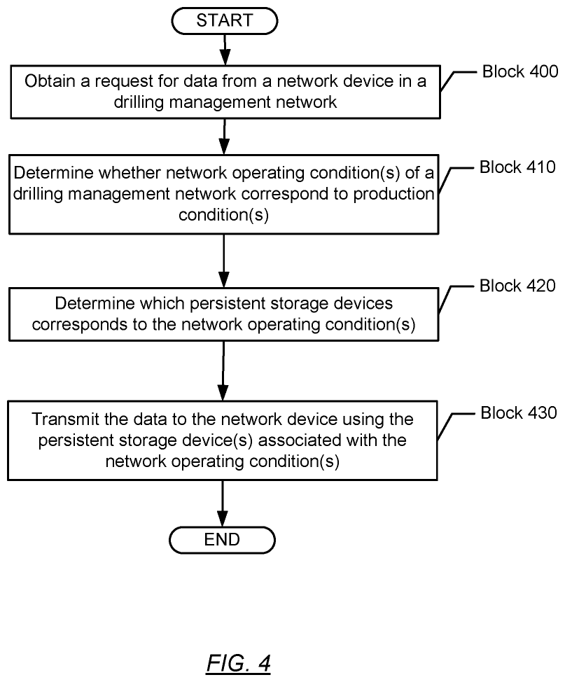

Turning to FIG. 4, FIG. 4 shows a flowchart in accordance with one or more embodiments. Specifically, FIG. 4 describes a method for accessing data from one or more persistent storages devices on a drilling management network. One or more blocks in FIG. 4 may be performed by one or more components (e.g., data management controller A (210)) as described in FIGS. 1, 2.1 and 2.2. While the various blocks in FIG. 4 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 400, a request for data is obtained from a network device in a drilling management network in accordance with one or more embodiments. For example, a user may provide a user input at a user device on a drilling management network to access data in a persistent storage device. The request may be a message that identifies data, the persistent storage device with the data, and/or a data type associated with the data. Thus, the request may be transmitted directly to a corresponding persistent storage device. In another embodiment, a data management controller may identify the persistent storage device with the data, e.g., based on a predetermined data type, and relay the request accordingly.

In Block 410, a determination is made whether one or more network operating conditions of a drilling management network correspond to one or more production conditions in accordance with one or more embodiments. For example, a data management controller, a persistent storage device, and/or another network device may monitor a drilling management network to determine whether the network operating conditions identify drilling operations or productions operations are occurring the network. For example, a virtualization services manager may determine whether drilling operations and/or production operations are present in the network, and transmit a notification that the network operating conditions are production conditions.

In Block 420, a determination is made which persistent storage devices are associated with one or more network operating conditions in accordance with one or more embodiments. In one or more embodiments, for example, persistent storage devices may be segregated based on whether the data is using for staging conditions or production conditions. Specifically, persistent storage devices for production conditions may include software images, data models, and other types of data that is being using in drilling operations or production operations. Thus, the data may be verified by one or more control systems as being stable for use by one or more control systems. Likewise, staging persistent storage devices may include untested data and/or data undergoing verification by the drilling management network.

In some embodiments, for example, multiple persistent storage devices are located in a data repository. Within the data repository, the staging persistent storage devices are decoupled from production persistent storages. For example, during normal rig operations, control systems on the rig will be connected to the production persistent storages. During staging tests, control systems switch to the staging persistent storage device in order to prevent corruption of production data and compromising software builds during the testing phase. Moreover during staging, production persistent storages may become a data backup for various control systems and network devices in the drilling management network.

In Block 430, data is transmitted to a network device using one or more persistent storage devices associated with one or more network operating conditions in accordance with one or more embodiments.

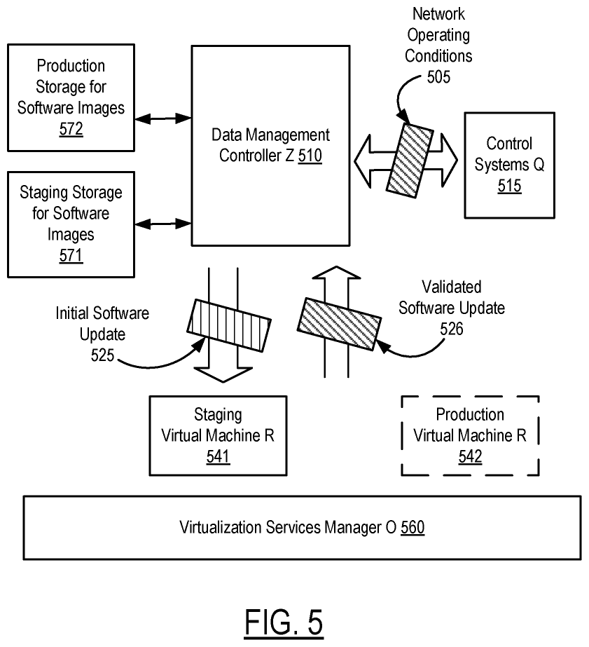

Turning to FIG. 5, FIG. 5 provides an example of updating software using a data storage architecture for a drilling management network. The following example is for explanatory purposes only and not intended to limit the scope of the disclosed technology.

FIG. 5 shows a data management controller Z (510) coupled to a production virtual machine R (542) operating on a virtualization services manager O (560), various control systems Q (515), a staging storage (571) for software images, and a production storage (572) for software images. The data management controller Z (510) monitors the control systems Q (515) to detect various network operating conditions (505) associated with a drilling management network (not shown). Initially, the data management controller Z (510) obtains a request to update software in the production virtual machine R (542). The staging virtual machine R (541) or the virtualization services manager O (560) may transmit the request to the data management controller Z (510). In another embodiment, the data management controller Z (510) automatically detects an initial software update (525) for a software application operating in the production virtual machine R (542), e.g., by accessing the Internet.

In response to obtaining the request to update software, the data management controller Z (510) and/or the virtualization services manager O (560) determine whether production operations are occurring in the drilling management network. Once production operations cease, the virtualization services manager O (560) terminates the production virtual machine R (542) and generates a staging virtual machine R (541). The staging virtual machine R (541) may be a virtual machine instantiation with similar functionality to the production virtual machine R (542). For example, the staging virtual machine R (541) may include additional functionality for debugging and/or monitoring software processes or hardware processes performed in connection to the staging virtual machine R (541).

As such, the virtualization services manager O (560) can test the initial software update (525) on the staging virtual machine R (541) before implementation in the production virtual machine R (542). Thus, the virtualization services manager O (560) may verify whether the software build on the staging virtual machine R (541) is stable and capable of performing various control processes under testing conditions before implementation in actual production conditions. Likewise, software code in the initial software update (525) may be modified on the staging virtual machine R (541), e.g., by changing configuration settings, adjusting processes associated with the software update to correspond to operations performed by one or more control systems, etc.

Once the staging virtual machine R (541) is generated, the data management controller Z (510) accesses the staging storage (571) where the initial software update (525) is stored. The data management controller Z (510) then transmits the initial software update (525) to the staging virtual machine R (541) for installation. The staging virtual machine R (541) may operate the updated software, make modifications to the initial software update (525), and perform various tests for a replacement virtual machine until a determination is made that the updated software can be used in a production virtual machine.

Moreover, the initial software update (525) or a modified software update may be further validated by an operator, other network devices, other staging virtual machines, etc. After validation, a validated software update (526) may be placed in the staging storage (571) and/or the production storage (572) if the update is ready for implementation in drilling operations. As such, the data management controller Z (510) may then distribute copies of the validated software update (526) to network devices in the drilling management network.

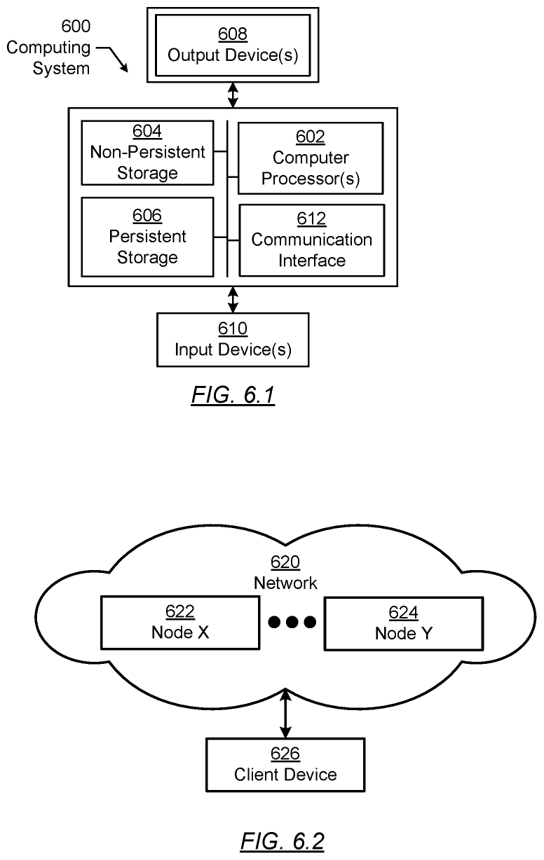

Embodiments may be implemented on a computing system. Any combination of mobile, desktop, server, router, switch, embedded device, or other types of hardware may be used. For example, as shown in FIG. 6.1, the computing system (600) may include one or more computer processors (602), non-persistent storage (604) (e.g., volatile memory, such as random access memory (RAM), cache memory), persistent storage (606) (e.g., a hard disk, an optical drive such as a compact disk (CD) drive or digital versatile disk (DVD) drive, a flash memory, etc.), a communication interface (612) (e.g., Bluetooth interface, infrared interface, network interface, optical interface, etc.), and numerous other elements and functionalities.

The computer processor(s) (602) may be an integrated circuit for processing instructions. For example, the computer processor(s) may be one or more cores or micro-cores of a processor. The computing system (600) may also include one or more input devices (610), such as a touchscreen, keyboard, mouse, microphone, touchpad, electronic pen, or any other type of input device.

The communication interface (612) may include an integrated circuit for connecting the computing system (600) to a network (not shown) (e.g., a local area network (LAN), a wide area network (WAN) such as the Internet, mobile network, or any other type of network) and/or to another device, such as another computing device.

Further, the computing system (600) may include one or more output devices (608), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (602), non-persistent storage (604), and persistent storage (606). Many different types of computing systems exist, and the aforementioned input and output device(s) may take other forms.

Software instructions in the form of computer readable program code to perform embodiments of the disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the disclosure.

The computing system (600) in FIG. 6.1 may be connected to or be a part of a network. For example, as shown in FIG. 6.2, the network (620) may include multiple nodes (e.g., node X (622), node Y (624)). Each node may correspond to a computing system, such as the computing system shown in FIG. 6.1, or a group of nodes combined may correspond to the computing system shown in FIG. 6.1. By way of an example, embodiments of the disclosure may be implemented on a node of a distributed system that is connected to other nodes. By way of another example, embodiments of the disclosure may be implemented on a distributed computing system having multiple nodes, where each portion of the disclosure may be located on a different node within the distributed computing system. Further, one or more elements of the aforementioned computing system (600) may be located at a remote location and connected to the other elements over a network.

Although not shown in FIG. 6.2, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (622), node Y (624)) in the network (620) may be configured to provide services for a client device (626). For example, the nodes may be part of a cloud computing system. The nodes may include functionality to receive requests from the client device (626) and transmit responses to the client device (626). The client device (626) may be a computing system, such as the computing system shown in FIG. 6.1. Further, the client device (626) may include and/or perform all or a portion of one or more embodiments of the disclosure.

The computing system or group of computing systems described in FIGS. 6.1 and 6.2 may include functionality to perform a variety of operations disclosed herein. For example, the computing system(s) may perform communication between processes on the same or different systems. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until the server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, one authorized process may mount the shareable segment, other than the initializing process, at any given time.

Other techniques may be used to share data, such as the various data described in the present application, between processes without departing from the scope of the disclosure. The processes may be part of the same or different application and may execute on the same or different computing system.

Rather than or in addition to sharing data between processes, the computing system performing one or more embodiments of the disclosure may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the disclosure, may extract one or more data items from the obtained data. For example, the extraction may be performed as follows by the computing system (600) in FIG. 6.1. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail—such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 6.1, while performing one or more embodiments of the disclosure, may perform data comparison. Data comparison may be used to compare two or more data values (e.g., A, B). For example, one or more embodiments may determine whether A>B, A=B, A !=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the disclosure, A and B may be vectors, and comparing A with B includes comparing the first element of vector A with the first element of vector B, the second element of vector A with the second element of vector B, etc. In one or more embodiments, if A and B are strings, the binary values of the strings may be compared.

The computing system in FIG. 6.1 may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 6.1 may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 6.1 and the nodes and/or client device in FIG. 6.2. Other functions may be performed using one or more embodiments of the disclosure.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A system, comprising:
a plurality of persistent storage devices disposed within a drilling management network;
one or more control systems comprising one or more programmable logic controllers (PLCs) configured for managing one or more drilling processes;
a data management controller coupled to the plurality of persistent storage devices; and
a plurality of network devices coupled to the data management controller, the one or more control systems, and the plurality of persistent storage devices,
wherein the data management controller is configured to:
obtain first data from a remote device over a network connection with the drilling management network,
determine a first persistent storage device among the plurality of persistent storage devices that corresponds to a first predetermined data type associated with the first data, and
store the first data in the persistent storage device associated with the first predetermined data type.

2. The system of claim 1,
wherein the data management controller is further configured to determine a chain of data transportation within the drilling management network of the first data, and
wherein the chain of data transportation describes a source of the first data into the drilling management network and use of the first data by the plurality of network devices.

3. The system of claim 2,
wherein the plurality of network devices comprises a network device configured to:
obtain the first data from the first persistent storage device,
modify the first data based on one or more staging operations using the one or more control systems to produce modified data,
storing the modified data in the first persistent storage device, and
wherein the chain of data transportation identifies the first data being transmitted into the drilling management network by the remote device, and usage and modification by the network device.

4. The system of claim 1, further comprising:
a central data repository comprising the plurality of persistent storage devices and the data management controller, and
wherein the data management controller is configured to transmit the first data in a persistent storage device among the plurality of persistent storage devices to a network device among the plurality of network devices.

5. The system of claim 1,
wherein at least one of the persistent storage devices is a virtual machine, and
wherein the virtual machine is configured to obtain a request for second data from one or more network devices, and
wherein the virtual machine is further configured to transmit the second data to the one or more network devices.

6. The system of claim 1,
wherein the data management controller is configured to determine whether a network operating condition of the drilling management network corresponds to a production condition of the drilling management network, and
wherein, in response to determining that the network operating condition corresponds to the production condition, the data management controller is configured to transmit second data from a production persistent storage device to a network device among the plurality of network devices.

7. The system of claim 6,
wherein, in response to determining that the network operating condition corresponds to a staging condition of the drilling management network, the data management controller is configured to transmit third data from a staging persistent storage device to a network device among the plurality of network devices.

8. The system of claim 1,
wherein the first predetermined data type corresponds to software images,
wherein the plurality of persistence storage devices comprises a second persistence storage device that corresponds to a second predetermined data type, and
wherein the second predetermined data type corresponds to data models.

9. The system of claim 1, further comprising:
a plurality of host devices comprising a virtualization services manager configured to operate on the plurality of host devices,
wherein the virtualization services manager is configured to generate a virtual machine or software container that implements at least one virtualization service on a network layer of the drilling management network, and
wherein the at least one virtualization service is configured to control at least one drilling operation.

10. The system of claim 1, further comprising:
a configuration manager configured to adjust one or more network configurations among the plurality of network devices,
wherein at least one of the plurality of persistent storage devices corresponds to a plurality of network configurations for the plurality of network devices, and
wherein the configuration manager is further configured to use the at least one of the plurality of persistent storage devices to adjust the one or more network configurations in response to one or more network operating conditions on the drilling management network.

11. A method, comprising:
obtaining, over a network connection, first data between a remote device and a drilling management network;
determining a first persistent storage device among a plurality of persistent storage devices that corresponds to a predetermined data type associated with the first data;
storing the first data in the persistent storage device associated with the predetermined data type; and
transmitting the first data in the persistent storage device to a first network device in the drilling management network.

12. The method of claim 11, further comprising:
identifying, by a data management controller, the predetermined data type associated with the first data, and
wherein the data management controller stores the first data in the first persistent storage device.

13. The method of claim 11,
wherein the first persistent storage device is a virtual machine, and
wherein the virtual machine obtain a request for second data from a second network device, and
wherein the virtual machine transmits the second data to the second network device in response to the request for the second data.

14. The method of claim 11,
wherein the first network device is a virtual machine that implements at least one virtualization service on a network layer of the drilling management network, and
wherein the at least one virtualization service is configured to control at least one drilling operation.

15. A method, comprising:
obtaining a request for first data from a first network device located in a drilling management network;
determining whether a network operating condition of the drilling management network corresponds to a production condition, wherein the drilling management network performs one or more drilling operations during the production condition;
determining, in response to the network operating condition corresponding to the production condition, a production persistent storage device among a plurality of persistent storage devices that corresponds to a predetermined data type associated with the first data; and
transmitting the first data from the production persistent storage device to the first network device.

16. The method of claim 15, further comprising:
determining that the network operating conditions is a staging condition, wherein the first data is a software image;
installing the software image to a second network device; and
operating the second network device using the software image while no production conditions are detected in the drilling management network.

17. The method of claim 16, further comprising:
modifying the software image based on one or more staging operations using one or more control systems to produce a modified software image;
validating the modified software image to produce a validated software image; and
storing the validated software image in a staging persistent storage device.

18. The method of claim 15, further comprising:
identifying, by a data management controller, the predetermined data type associated with the first data, and
wherein the data management controller stores the first data in the first persistent storage device.

19. The method of claim 15,
wherein the first persistent storage device is a virtual machine, and
wherein the virtual machine obtains a request for second data from a second network device, and
wherein the virtual machine transmits the second data to the second network device in response to the request for the second data.

20. The method of claim 15,
wherein the first network device is a virtual machine that implements at least one virtualization service on a network layer of the drilling management network, and
wherein the at least one virtualization service is configured to control at least one drilling operation.
